(19) United States
(12) Patent Application Publication
(10) Pub. No.: US 2002/0138606 A1
(43) Pub. Date: Sep. 26, 2002

(54) Method and apparatus for determining network connection by links

(76) Inventor: Jeremiah Robison, San Francisco, CA (US)

Correspondence Address: OPENWAVE SYSTEMS INC., 1400 SEAPORT BLVD., REDWOOD CITY, CA, 94063, US

(21) Appl. No.: 09/765,980

(22) Filed: Jan. 20, 2001

(51) Int. Cl. G06F 15/173

(52) U.S. Cl. 709/224

(57) ABSTRACT

A method and apparatus for determining network connections by links is disclosed. According to one embodiment, a mobile device includes a client application and communicates with a link server over a wireless network. In response to an activation of a link in a display being displayed on a screen of the mobile device, the client application determines if the link leads to an internal access or an external access. The internal access is defined to retrieve desired information without accessing the network, hence no usage of the network. Likewise, the external access is defined to retrieve desired information from the network, hence usage of the network.

### CROSS-REFERENCE TO RELATED APPLICATION

This application relates to pending U.S. patent application Ser. No. 08/978,701, entitled “METHOD AND ARCHITECTURE FOR AN INTERACTIVE TWO-WAY DATA COMMUNICATION NETWORK”, filed on Nov. 26, 1998, which is hereby incorporated by reference, both are commonly assigned.

### BACKGROUND OF THE INVENTION

1. Field of the Invention

This invention relates generally to data communications, and in particular to an interactive two-way communication mobile device that permits a user to interact with a network server providing hypermedia information through a data network including the Internet and a wireless network, wherein the mobile devices displays hyperlinks in a way that a user thereof knows if the hyperlinks lead to local memory access or network connections once activated.

2. Description of the Related Art

The Internet is a rapidly growing communication network of interconnected computers and computer networks around the world. Together, these millions of connected computers form a vast repository of multimedia information that is readily accessible by any of the connected computers from anywhere at any time. To navigate the Internet, the connected computers like workstations and desktop computers typically operate what is commonly called “browser”, an application (client) program that generally uses the Hypertext Transfer Protocol (HTTP) to make requests to the multimedia information throughout the Internet.

To provide mobility and portability of the Internet, interactive two-way communication mobile devices are introduced and capable of communicating, via wireless data networks, with the Internet. The interactive two-way communication mobile devices, including two-way pagers, cellular phones, palm-sized computing devices and personal digital assistant (PDA) apparatuses are among the fastest emerging communication devices introduced recently that enable users to receive, collect, analyze, review and disseminate information as they travel or move about.

The mobile devices are typically serviced through one or more wireless service carriers that charge service fees for the usage of their wireless networks, typically in minutes. While the service fees are reducing substantially amid market competitions among the carriers, they are however psychologically a barrier to populating the use of the mobile devices as it is under the impression that each retrieval of information from the network may incur a cost to the user. There is thus a need for a visual indicator on a mobile device as to what information retrieval may or may not incur a cost to the user.

### SUMMARY OF THE INVENTION

The present invention has been made in consideration of the above described problems and needs and has particular applications to the navigation of Internet web pages by two-way interactive communication mobile devices. The mobile devices may include, but not be limited to, mobile computing devices, cellular phones, palm-sized computer devices, personal digital assistant devices and Internet-capable appliance remote controllers, and are capable of communicating wirelessly with one or more service providers or network servers on the Internet via a link server.

According to one aspect of the present invention, a mobile device includes a client application and communicates with a link server over a wireless network. In response to an activation of a link in a display being displayed on a screen of the mobile device, the client application determines if the link leads to an internal access or an external access. The internal access is defined to retrieve desired information without accessing the network, hence no usage of the network. Likewise, the external access is defined to retrieve desired information from the network, hence usage of the network.

To facilitate the internal access, data received in response to a request sent out to the network may include additional information that are linked directly/indirectly from a network resource being requested and is cached in a temporary memory space. If some of the links leading to the cached information are activated, such retrieval requests can be fulfilled without accessing the network.

According to another aspect of the present invention, the links leading to the cached information are displayed in a fashion that the desired resources are locally available, hence no network access is to take place and no cost may incur to the user when these links are activated. According to one embodiment of the present invention, a predetermined color is designated to these links to distinguish from other links that will cause network access if they are activated.

This invention can be implemented in various ways, as a method, an apparatus or a software product executable on a mobile device. Each of the implementation may yield one or more of the following advantages and benefits. First one is now that a user who may be sensitive to cost is now in control of the network usage by examining how a link is displayed. Second one is the possible traffic reduction by caching auxiliary data in a local memory space for possible local access so as to reduce the traffic in the network.

Accordingly, one of the objects of this invention is to provide a generic solution to two-way communication mobile devices that can effectively interact with a network such as the Internet and a wireless network.

Other objects, together with the foregoing are attained in the exercise of the invention in the following description and resulting in the embodiment illustrated in the accompanying drawings.

### BRIEF DESCRIPTION OF THE DRAWINGS

The present invention will be readily understood by the following detailed description in conjunction with the accompanying drawings, wherein like reference numerals designate like structural elements, and in which:

FIG. 1 illustrates a schematic configuration in which the present invention may be practiced;

FIG. 2 illustrates an internal functional block diagram of an exemplary mobile device that may correspond to one of the mobile devices of FIG. 1;

FIGS. 3A and 3B illustrate respectively two displays on a display screen of a mobile device embodying one implementation of the present invention;

FIG. 4 depicts data received from a network, wherein the data includes a plurality of other related displays or network resources in addition to what is being requested present invention; and

FIG. 5 shows a process flowchart of the present invention according to one embodiment.

### DETAILED DESCRIPTION OF THE INVENTION

In the following detailed description of the present invention, numerous specific details are set forth in order to provide a thorough understanding of the present invention. However, it will become obvious to those skilled in the art that the present invention may be practiced without these specific details. In other instances, well known methods, procedures, components, and circuitry have not been described in detail to avoid unnecessarily obscuring aspects of the present invention. The detailed description is presented largely in terms of procedures, logic blocks, processing, and other symbolic representations that directly or indirectly resemble the operations of data processing devices coupled to networks. These process descriptions and representations are the means used by those experienced or skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

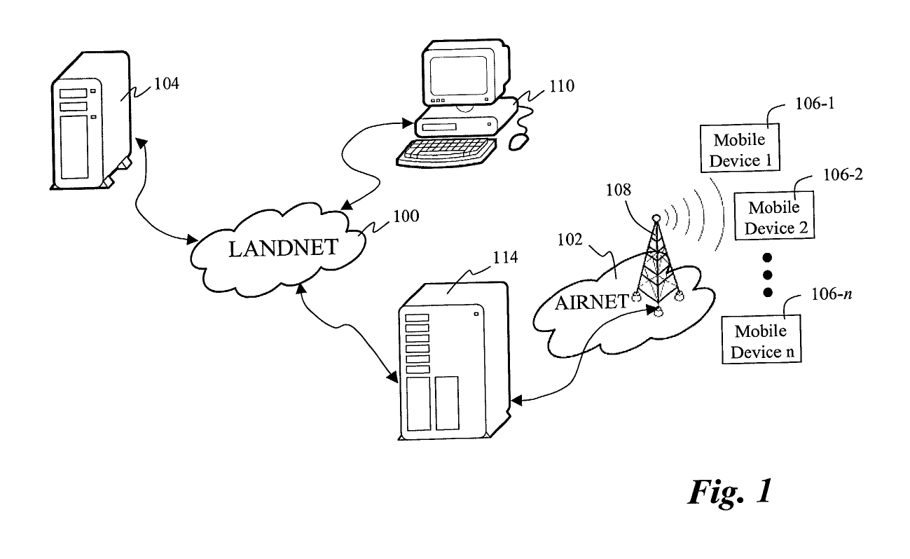

Referring now to the drawings, in which like numerals refer to like parts throughout the several views. FIG. 1 illustrates a schematic configuration in which the present invention may be practiced. Landnet 100 is a landline network that may be the Internet, the Intranet and a data network of other private or public networks. Coupled to landnet 100 are a personal computer (PC) 110 and a network server 104. Personal computer 110 may be a desktop personal computer. Preferably, personal computer 110 runs a HyperText Markup Language (HTML) browser, such as Netscape Navigator from Netscape Communications Corporation (http://www.netscape.com/) via landnet 100 using HyperText Transfer Protocol (HTTP) to access information stored in network server 104 that may be a workstation from SUN Microsystems Inc (http://www.sun.com/). The information stored in network server 104 may be hypermedia information including mobile data designed for mobile devices.

There are n mobile devices 106 serviced by airnet 102. Mobile devices 106 are the interactive two-way communication devices that include, but are not limited to, mobile computing devices, cellular phones, palm-sized computing devices with PDA (Personal Data Assistants) functionality and Internet-capable appliance remote controllers, and capable of communicating wirelessly with antenna 108 via airnet 102. For simplicity, antenna 108 also represents a wireless carrier infrastructure that generally comprises a base station and an operations and maintenance center. The base station controls radio or telecommunication links with mobile devices 106. The operations and maintenance center comprises a mobile switching center performing the switching of calls between the mobile devices and other fixed or mobile network users. Further the operations and maintenance center manages mobile account services, such as authentication, and oversees the proper operation and setup of the wireless network. Each of the hardware components and processes in carrier infrastructure 108 are known to those skilled in the art and not to be described herein to avoid unnecessarily obscuring aspects of the present invention.

Between landnet 100 and airnet 102 there is a link server device 114 functioning as a bridge between the two networks 100 and 102. Link server device 114, also referred to as proxy server or wireless data server or network gateway server, may be a workstation or a personal computer. Link server 114, couples airnet 102 to landnet 100, facilitates the communication of mobile devices 106 with any of the devices coupled to landnet 100.

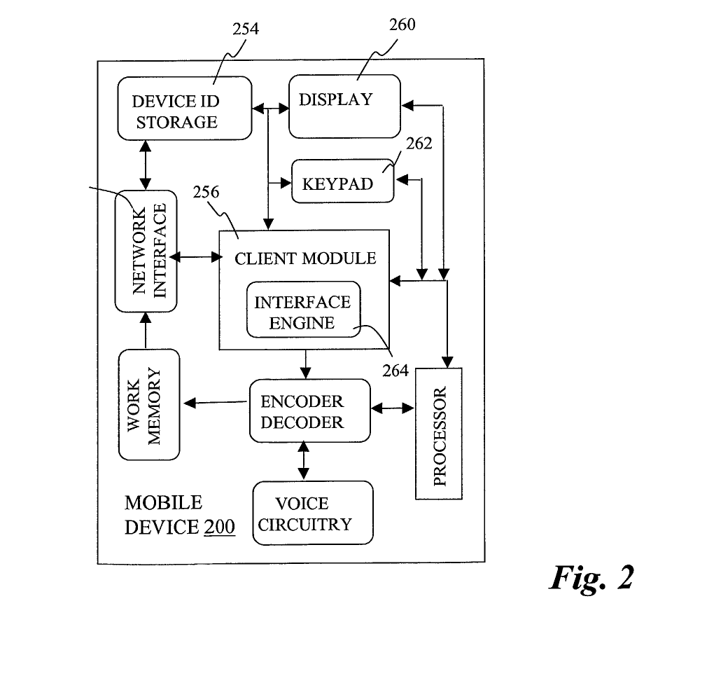

FIG. 2, there is shown a functional block diagram of a mobile device according to an embodiment of the present invention. To avoid obscuring aspect of the present invention, well known methods, procedures, components and circuitry in mobile device 200 are not described in detail. Mobile device 200 includes a wireless network interface 202 that couples to a wireless network 204 via a RF transceiver (not shown in the figure) to receive incoming and outgoing data signals. Wireless network interface 202 facilitates communications between wireless network 204 and mobile device 200 and may be implemented according to the nature of the wireless network. The exact implementation of the wireless network interface does not affect the operations of the present invention. One exemplary implementation of the wireless network interface is based on Wireless Application Protocol (WAP) promulgated by the WAP forum (www.wapforum.com). Another exemplary implementation of the wireless network interface may simply conform to Hypertext Transfer Protocol (HTTP).

Device identifier (ID) storage 206 supplies a device ID to network interface 202. The device ID identifies a specific code that is associated with mobile device 200 and may directly correspond to a user account in an application server or a proxy server, such as server 104 or 114 of FIG. 1. Display 208 is a display screen, such as a 4 lines by 20 characters LCD, for displaying data received from the network or entered by a user through a keypad or an data entry means 210.

Working memory 212 refers to all memory spaces available in mobile device 200. In particular, a space of certain size, for example, 256K bytes, is allocated from working memory 212. By virtue of the present invention, the space, referring to as a cache, is configured to cache data received from the network, wherein only part of the data is being requested for displaying on display screen 208.

In addition, mobile device 200 includes a client module 214 that performs many of processing tasks performed by the mobile device 200 including establishing a communication session with a server via a wireless network, requesting and receiving data therefrom, displaying data on display screen 208, and receiving user input as well. Specifically, client module 214, when executed by a processor 216, is coupled to network interface 202 to establish a communication session conforming to a protocol, request and receive data in the cache, and cause part of the data to be displayed on display 208.

In operation, a chuck of data is received when a request is made to retrieve pertinent information. From the communication efficiency perspective, it is generally preferable to send more than is requested if the requested data is small in size to better utilize the network bandwidth. For example, a data packet is defined to have a maximum length. When the requested data is far less than the maximum length, addition data could be appended to the requested data without affecting transmission of the requested data. The data appending approach, improving transmission efficiency, avoids unnecessary traffic in the network that may result from repeated accesses to a small chunk of data.

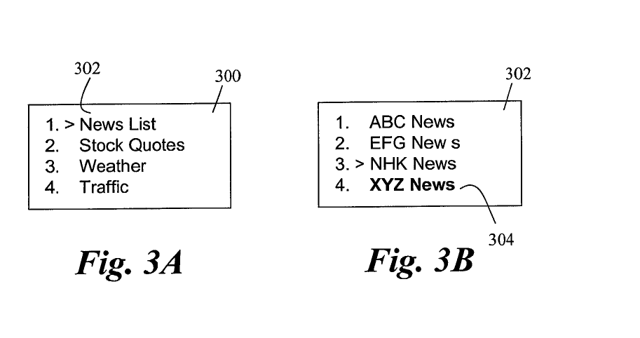

FIG. 3A shows an example of a menu display 300 displayed on a display screen of a mobile device. As used herein, a display means an image to be displayed on a display screen that is an apparatus, such as an LCD screen. A display is formed by an application executing one or more files received as a network resource from the network, such as the Internet. Generally, a network resource includes one or more files that result in one or more displays when executed by the application. One of such applications is a micro-browser available from Openwave Systems, Inc. having a business address of 800 Chesapeake Drive Redwood City, Calif. 94063 USA.

Display 300 is a hypertext including a list of selectable items or objects: “News List”, “Stock Quotes”, “Weather”, and “Traffic”, each is being embedded with a hyperlink. Generally, hyperlink is a synonym for both link and hypertext link. Using hypertext, a link is a selectable connection from one word, picture, or information object to another. Links are what make the World Wide Web a web. In a multimedia environment such as the World Wide Web, selectable objects can include sound and motion video sequences. The most common form of link is the highlighted word or picture that can be selected or activated by the user (with a pointing device, a positioning key or in some other fashion), resulting in the immediate retrieval and view of another file. As shown in the figure, item 302 is being selected. Upon activated, a request is generated to fetch “News List” provided from a server that provides such “News List”. The server may be identified by an IP address, such as www.newlists.com.

It is assumed that a “News List” includes a list of sites that respectively provide news information and hence such list constitutes a display embedding a link to a network resource provided by a news site. It is assumed that the network resource of the “News List” is small in data size. It is not efficient but contributing to network traffic if a network resource including the “News List” is just sent alone. Generally, other network resources related to the network resource of the “News List” is preferably packed together or piggybacked to better utilize the available bandwidth of the network.

FIG. 3B shows a display 310 as a result of the activation of item 302 in FIG. 3A. Display 310 includes a list of detailed news categories available for the user to choose from. Each of the news categories, when selected, will bring the user to a corresponding site that has the news. As described above, when the network resource of the “News List” arrives, additional related network resources come together and preferably cached in a temporary space of the mobile device. As one of the features in the present invention, the link in the presently displayed network resource is highlighted, displayed, or colored differently from other links if one of the additional related network resources is being pointed by the link.

As shown in display 310, item “XYZ News” is a link but displayed in a fashion different from other links “ABC News”, “EFG News” and “NHK News”. The display difference indicates to the user that the network resource linked by the specially displayed link is locally available. Economically, the user may be informed that the access to this specially displayed link will not incur costs to his/her account as there is no connection over the network if the specially displayed link is selected.

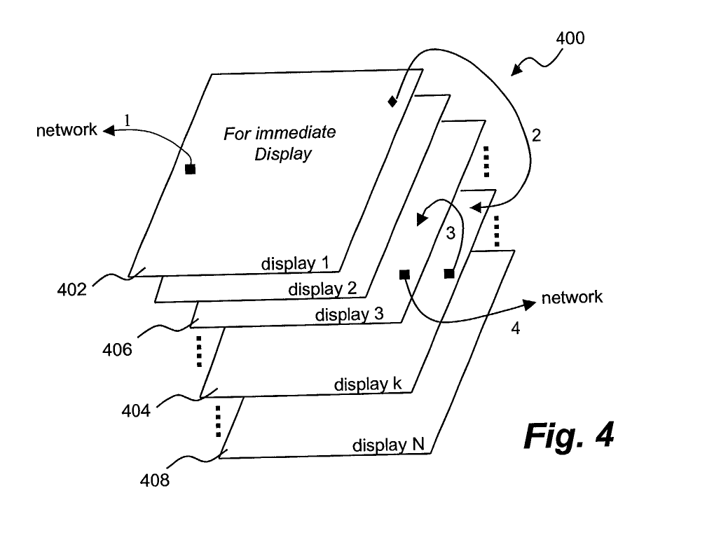

FIG. 4 graphically illustrates received data 400 from the network in response to a request being sent out to the network. Data 400 includes a number of network resources (or displays), only one of which is actually being requested by the request. Upon arriving in the mobile device, data 400 is cached in a memory space, such as cache memory. Display 1 is assumed to be the one that is requested and typically is input to the display screen for immediate display. Display 1 includes two links 1 and 2. Link 1 points to a new network resource and, if activated, will cause the mobile device to generate a new request to fetch the new network resource. Link 2 points to a cached network resource k or display k. To distinguish the two different links, link 1 may be displayed in red and link 2 may be displayed in blue according to one embodiment of the present invention. Other display schemes or fashion may be employed. The key feature herein is that the differently displayed links enable the user to see which link will incur new fetch over the network and which link leads to locally available information.

If display k is displayed, links in display k are similarly displayed. Link 3 is shown to be locally available and link 4 leads to a new fetch over the network.

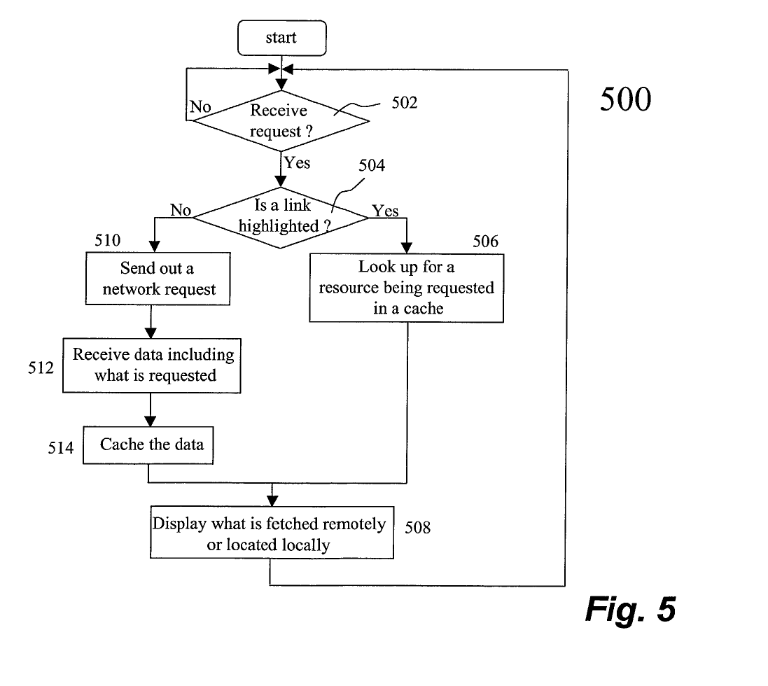

FIG. 5 shows a process flowchart according to one embodiment of the present invention and shall be understood in conjunction with the preceding figures. Process 500 may be implemented as a method, an apparatus or a software product implemented in a mobile device capable of data communication with a server over a wireless network.

In operation, a user of the mobile device enters a command, or selects/activates a link that causes the mobile device to generate a request. At 502, process 500 awaits such request. When the request is generated, the request is examined to see if it is for external access or internal access. Typically, the request includes an address (e.g. a URL or unified resource locator) identifying a resource available for such access. As described above, the locally available resources are respectively indicated by links in a different display than other links. According to one embodiment, a link causing an external access is in red color and a link causing an internal access is blue color. There are many possible implementations. One exemplary implementation is as follows:

if (a source is stored in the cache)
{

| | |
|---|---|
| color the link in the vlink color; | //vlink = blue |

| | |
|---|---|
| update the original URL; | //option depending on |

//actual implementation

}
else
{

| | |
|---|---|
| color the link in the link color; | //link = red |

}

wherein “update the original URL” is to replace with an internal memory address. Hence when the link “in the vlink color” is executed, a memory access (i.e. internal access) takes place. Although a user may not perceive any difference in requesting a desired resource, the response to the activation of such link is typically faster than otherwise the links leading to an external access over the network.

At 504, the address in the request is examined. Alternatively, the color, which is a predefined color, of the link is examined. Accordingly, there are two possibilities from the link: internal or external access. Generally, for external access, the address in the request is an IP address, for example: www.newsagency.com. For internal access, the address in the request may be a memory address, for example, 6AFF10 (in hexadecimal) at which an appropriate display or a cached network resource is stored.

If the link is for internal access, process 500 goes to 605 to look up for the resource cached in a cache according to the link in the request. The display or resource cached is then retrieved and sent to the display screen for display at 508. As described above, the retrieved display or resource may include links that may either result in an external access or an internal access.

If the link is for external access, process 500 goes to 510 to send out the request including the link which is an address identifying a web site. According to one embodiment, the request conforms to a communication protocol in the network that carries the request through to the web site. Examples of the communication protocol may include Hypertext Transfer Protocol (HTTP) and Wireless Application Protocol (WAP).

At 512, data according to the link in the request is received from the network. As described above, the data includes more than what is being requested. Depending on the server, the data includes what is being requested and may include or piggyback a number of displays or resources related to the resource being requested. At 514, the “extra” displays or resources that are related to the resource being requested are cached in a temporary memory space. At the same time, the links in the resource being requested to the cached displays and resources are updated with the memory address. In an alternative implementation, the links are not updated. Accordingly, at 504, a judgement can be configured to determine if a link is for internal or external access, which may be done by tabulating the links of internal access. At 508, the display or resource being requested is output to the display screen for display. Again the display or resource being displayed may include links that may either result in an external access or an internal access.

The present invention may be implemented as a method, an apparatus, or a software product executable on a computing device. Each of the implementation may yield one or more of the following advantages and benefits. One of the advantages and benefits is now that a user who may be sensitive to cost is now in control of the network usage. Another one of the advantages and benefits is the possible traffic reduction by caching auxiliary data in a local memory space for possible access to avoid unnecessary network access so as to reduce the traffic in the network. Other advantages and benefits are evident to those skilled in the art from the description above and the claims to be followed.

The present invention has been described in sufficient detail with a certain degree of particularity. It is understood to those skilled in the art that the present disclosure of embodiments has been made by way of example only and that numerous changes in the arrangement and combination of parts as well as steps may be resorted without departing from the spirit and scope of the invention as claimed. Accordingly, the scope of the present invention is defined by the appended claims rather than the forgoing description of embodiments.

1. A method for a mobile device to retrieve multimedia information from a server over a wireless network, the method comprising:
receiving data from the wireless network after a request of a network resource is sent thereto, wherein the data includes a plurality of network resources one of which is the network resource being requested and includes at least one link to another one of the network resources; and
displaying the network resource being requested and the at least one link being highlighted in a fashion that indicates the another one of the network resources is locally available.

2. The method of claim 1 further comprising storing the data in a temporary memory space in the mobile device.

3. The method of claim 1, wherein the fashion is to have the at least one link displayed in a different color than other links in the network resource being displayed.

4. The method of claim 2, wherein each of the other links, if activated, will cause a new request to be sent to the wireless network.

5. The method of claim 2, wherein the at least one link, if activated, will not cause a new request to be sent to the wireless network.

6. The method of claim 5, wherein the data is cached in a temporary memory space in the mobile device and further comprising fetching the another one of the network resources from the temporary memory space when the new request is activated.

7. A mobile device for retrieving multimedia information from a server over a wireless network, the mobile device comprising:
a display screen;
a temporary memory space coupled to the display screen;
a processor synchronizing operations of both the display screen and the temporary memory space;
wherein the temporary memory space caches data received from the wireless network in response to a request sent to the wireless network for a network resource, the data includes a plurality of network resources one of which is the network resource being requested and includes at least one link to another one of the network resources; and
wherein the processor causes the at least one link to be displayed in a highlighted fashion in the network resource when the network resource is displayed on the display screen.

8. The mobile device of claim 7, wherein the highlighted fashion is to have the at least one link displayed in a different color than other links in the network resource being displayed.

9. The mobile device of claim 8, wherein each of the other links, if activated, will cause a new request to be sent to the wireless network.

10. The mobile device of claim 8, wherein the at least one link, if activated, will not cause a new request to be sent to the wireless network.

11. The mobile device of claim 9, wherein the processor causes the another one of the network resources to be fetched from the temporary memory space when the new request is activated.

12. A software product to be executed in a mobile device, the software product comprising:
program code for receiving data from the wireless network after a request of a network resource is sent thereto, wherein the data includes a plurality of network resources one of which is the network resource being requested and includes at least one link to another one of the network resources; and
program code for displaying the network resource being requested, and
program code for displaying the at least one link in a fashion that indicates the another one of the network resources is locally available.

13. The software product of claim 12 further comprising program code for storing the data in a temporary memory space in the mobile device.

14. The software product of claim 13, wherein the fashion is to have the at least one link displayed in a different color than other links in the network resource being displayed.

15. The software product of claim 14, wherein each of the other links, if activated, will cause a new request to be sent to the wireless network.

16. The software product of claim 14, wherein the at least one link, if activated, will not cause a new request to be sent to the wireless network.

17. The software product of claim 16 further comprising program code for fetching the another one of the network resources from the temporary memory space when the new request is activated.
